(19) United States
(12) Patent Application Publication
(10) Pub. No.: US 2009/0278033 A1
(43) Pub. Date: Nov. 12, 2009

(54) Optical trace detecting module

(75) Inventors: Li-Wen Lin, Taipei County (TW); Chien-Mo Lai, Taipei County (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei County (TW)

(21) Appl. No.: 12/289,123

(22) Filed: Oct. 21, 2008

(30) Foreign Application Priority Data
May 9, 2008 (TW) 097117289

(51) Int. Cl. H01J 40/14

(52) U.S. Cl. 250/221

(57) ABSTRACT

An optical trace detecting module includes a light-pervious plate, a circuit board, and a light guiding element. The light-pervious plate contacts an object and allows the object to move on a surface thereof. The circuit board is electrically disposed with an optical sensor and a light source. The light guiding element is disposed between the light source and the light-pervious plate. A sensing light projected from the light source is converged and guided by the light guiding element so as to be projected onto a contact region of the light-pervious plate.

### CROSS-REFERENCE TO RELATED APPLICATIONS

This non-provisional application claims priority under 35 U.S.C. §119(a) on Patent Application No(s). 097117289 filed in Taiwan, R.O.C. on May 9, 2008 the entire contents of which are hereby incorporated by reference.

### BACKGROUND OF THE INVENTION

1. Field of Invention

The present invention relates to a movement tracking sensor, and more particularly, to an optical trace detecting module with a light guiding element.

2. Related Art

With the development and progress of science and technology, computer equipments, no matter the personal computers (PCs), notebooks, mobile phones, or personal digital assistants (PDAs), have become indispensable tools for providing convenience in people's daily life or work. However, window interfaces of the computer equipments can only be manipulated through pointing input devices, such as a mouse, touchpad, and trackball.

Take the mouse for example. In recent years, a touch control module capable of manipulating a cursor and executing a preset function is further developed to completely replace the functions of the optical sensor module and buttons of a conventional mouse. The touch control module is disposed in an upper housing of the mouse. A user may selectively manipulate the position of the cursor through the optical sensor module on the bottom of the mouse or slide a finger on the touch control module to generate a corresponding control signal.

The optical elements of the conventional touch control module are separated from each other, and a light projected from a light emitting diode (LED) must be accurately projected to the user's finger in the opening. Therefore, a projection distance between the LED and the opening has to be relatively elongated, resulting in an increase of the volume of a portable electronic device, and the electronic device cannot be thinned. In addition, in the manufacturing, the layout of the components and the touch control module inside the electronic device must be considered, such that the manufacturing processes are increased. Thereby, electronic devices installed with the touch control module are always sold at a high price, and are unable to meet the current requirements of light, thin, and inexpensive electronic devices.

In addition, since the conventional touch control module needs an excessively large space to be assembled, except pointing input devices like a mouse, it cannot be installed in portable electronic devices such as mobile phones, PDAs, and tablet computers.

### SUMMARY OF THE INVENTION

Accordingly, the present invention is directed to an optical trace detecting module, so as to solve the problems that the LED and the optical sensor of the touch control module are separated optical components, such that the touch control module has a limited size and is difficult to be thinned, the assembly is too complicated, and the manufacturing cost is excessively high.

An optical trace detecting module includes a light-pervious plate, a circuit board, an imaging lens, and a light guiding element. The light-pervious plate contacts an object and allows the object to move on a surface thereof. The circuit board is electrically disposed with an optical sensor and a light source. The imaging lens is disposed between the light-pervious plate and the optical sensor. The light guiding element is disposed between the light source and the light-pervious plate. The light source projects a sensing light to the light guiding element. The light guiding element converges, guides, and projects the light to a contact region of the light-pervious plate. The object then reflects the light to the imaging lens to be imaged. Finally, the reflected light is further focused on the optical sensor and received by the same.

The present invention achieves the following efficacy. The optical sensor and the light source are integrally disposed on a circuit board, and a sensing light projected by the light source is converged and guided by the light guiding element. As such, the above modular design may significantly reduce the volume of the optical movement tracking sensor, and thus achieve the purpose of thinning.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a first embodiment of the present invention;

FIG. 2 is a schematic view of a second embodiment of the present invention;

FIG. 3 is a schematic view of a third embodiment of the present invention;

FIG. 4 is a schematic view of a fourth embodiment of the present invention;

FIG. 5 is a schematic view of a fifth embodiment of the present invention; and

FIG. 6 is a schematic view of a sixth embodiment of the present invention.

### DETAILED DESCRIPTION OF THE INVENTION

The optical trace detecting module provided by the present invention is applicable to an electronic device, including, but not limited to, an electronic device with an input interface such as a mouse, trackball, mobile phone, PDA, or notebook. In the following detailed description of the present invention, the mouse is taken as the most preferred embodiment. The accompanied drawings are for reference and illustration only, instead of limiting the present invention.

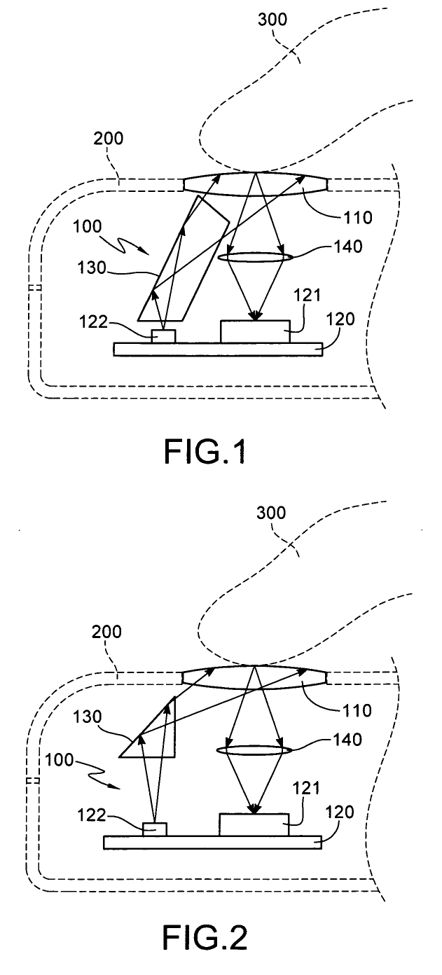

FIG. 1 is a schematic view of a first embodiment of the present invention. The optical trace detecting module 100 of the present invention is installed in an electronic device 200, and includes a light-pervious plate 110, a circuit board 120, a light guiding element 130, and an imaging lens 140. The light-pervious plate 110 is mounted on a housing of the electronic device 200, so as to contact an object 300 (for example, a finger of a user) and allow the object 300 to move on a surface thereof.

The circuit board 120 is electrically disposed with an optical sensor 121 and a light source 122, and the imaging lens 140 is disposed between the light-pervious plate 110 and the optical sensor 121. The optical sensor 121 is corresponding to the light-pervious plate 110, and the light source 122 may project a sensing light to the light-pervious plate 110. The light penetrates the light-pervious plate 110 and is projected out of the housing of the electronic device 200, so as to be projected onto the object 300 (i.e., the finger of the user) sliding on the light-pervious plate 110, and then reflected to the imaging lens 140. Next, the refracted light is focused on the optical sensor 121, so as to calculate a relative displacement between the object 300 and the optical trace detecting module 100, and then generate a corresponding control signal. The method of detecting and calculating the displacement at least includes an image detection mode or an optical detection mode, which will not be described in detail herein for not being the subject matter of the present invention.

The light-pervious plate 110 is a light transmissive board or a lens made of acryl, glass, or other materials capable of preventing the sensing efficiency of the optical trace detecting module 100 from being reduced. In addition, the optical sensor 121 may be a charge coupled device (CCD) or a complementary metal-oxide semiconductor (CMOS), and the light source 122 may be a direct-type LED, a side-type LED, or any other light emitting element so as to project a directive light.

The light-pervious plate 110 in the present invention is a biconvex lens, such that the user may operate comfortably with a finger sliding on the light-pervious plate 110. Furthermore, the design of the biconvex lens may also assist the imaging of the reflected image of the object 300, thus significantly reducing the overall height of the optical trace detecting module 100.

Referring to FIG. 1, the light guiding element 130 of the first embodiment of the present invention is a light guiding pillar disposed between the light source 122 and the light-pervious plate 110. When the light source 122 projects the sensing light to the light guiding pillar, the light guiding pillar converges, guides, and projects the light to a contact region of the light-pervious plate 110, i.e., a region where the object 300 moves on the surface of the light-pervious plate 110, such that the light projected by the light source 122 may be projected onto the object 300 efficiently, thus enhancing the sensing efficiency of the optical trace detecting module 100.

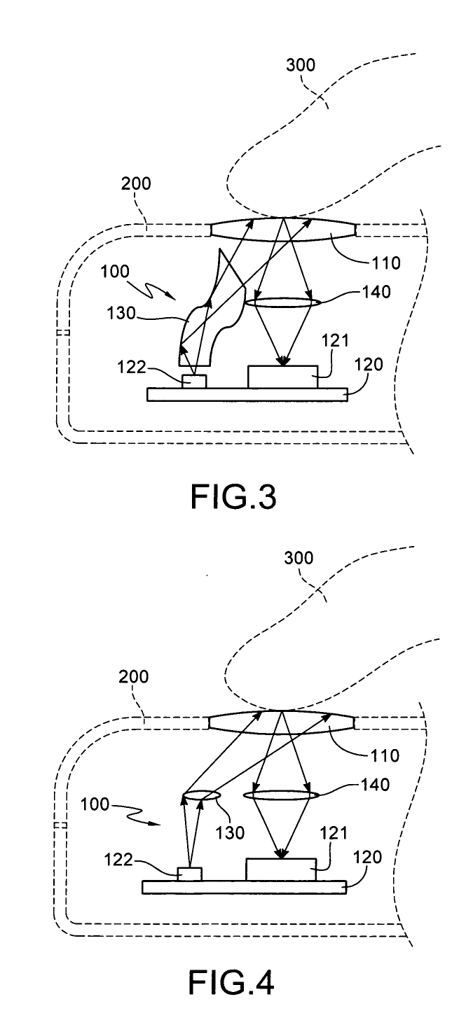

FIG. 2 is a schematic view of a second embodiment of the present invention. As shown in FIG. 2, the light guiding element 130 of the second embodiment is a reflecting prism disposed between the light source 122 and the light-pervious plate 110. The light source 122 projects a sensing light to the reflecting prism. Then, the light is projected onto a contact region of the light-pervious plate 110 (a region where the object 300 moves on the surface of the light-pervious plate 110) under the guide of the reflecting prism, so as to efficiently project the light projected from the light source 122 onto the object 300. FIG. 3 is a schematic view of a third embodiment of the present invention. The light guiding element 130 is a reflecting prism. The reflecting surface of the reflecting prism 130 is a circular-arc curved surface capable of efficiently converging the light projected from the light source 122 and guiding the light to be projected onto the light-pervious plate 110.

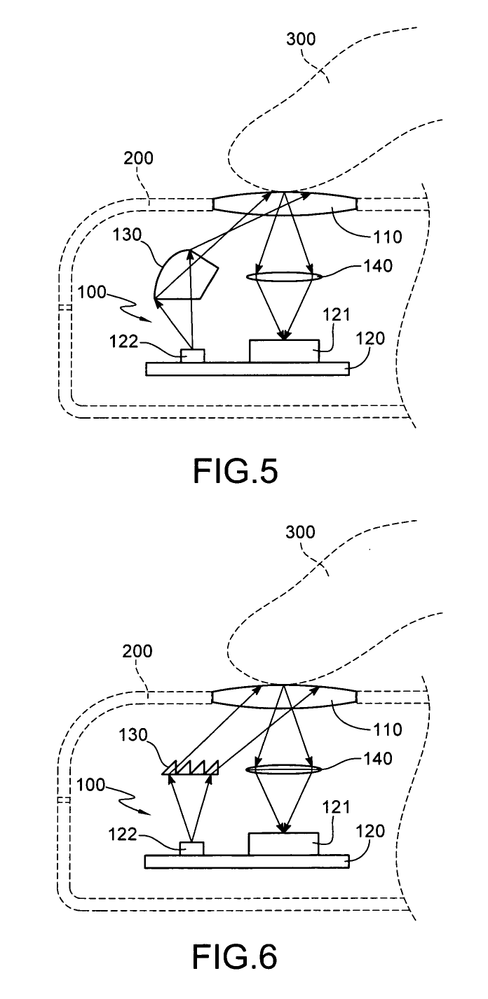

In addition, FIGS. 4 to 6 are schematic views of a fourth to a sixth embodiment. The light guiding element 130 of the present invention may also be an optical fiber, a condenser lens, or a Fresnel lens, so as to effectively project the sensing light from the light source 122 onto the light-pervious plate 110. After that, the reflected image of the object 300 is received by the optical sensor 121 to generate a displacement control signal.

The light guiding element 130 may be any of those disclosed in the above embodiments. However, those skilled in the art may adopt different light guiding manners instead of being limited to the embodiments of the present invention.

In the present invention, the optical sensor and the light source are electrically disposed on the same circuit board, and the sensing light can be effectively guided and projected onto the light-pervious plate by the light guiding element, such that the optical trace detecting module achieves the light guiding and imaging functions at the same time. The modular design of the optical trace detecting module of the present invention not only greatly reduces the volume of the optical trace detecting module, but also simplifies the process, so as to fulfill the purposes of thinning, reducing the manufacturing cost, and enhancing the assembly.

What is claimed is:

1. An optical trace detecting module, comprising:
a light-pervious plate, for contacting an object and allowing the object to move on a surface thereof;
a circuit board, electrically disposed with an optical sensor and a light source, wherein the light source projects a sensing light to the light-pervious plate, and the optical sensor receives a reflected image of the object;
an imaging lens, disposed between the light-pervious plate and the optical sensor; and
a light guiding element, disposed between the light source and the light-pervious plate;
wherein the light source projects the sensing light to the light guiding element, the light guiding element converges, guides, and projects the light to a contact region of the light-pervious plate, the object then reflects the light to the imaging lens, the reflected light is further focused on the optical sensor, and the optical sensor senses the movement of the object and generates a corresponding control signal.

2. The optical trace detecting module according to claim 1, wherein the light guiding element is a light guiding pillar.

3. The optical trace detecting module according to claim 1, wherein the light guiding element is a reflecting prism.

4. The optical trace detecting module according to claim 3, wherein a reflecting surface of the reflecting prism is a circular-arc curved surface.

5. The optical trace detecting module according to claim 1, wherein the light guiding element is an optical fiber.

6. The optical trace detecting module according to claim 1, wherein the light guiding element is a condenser lens.

7. The optical trace detecting module according to claim 1, wherein the light guiding element is a Fresnel lens.

8. The optical trace detecting module according to claim 1, wherein the light-pervious plate is a biconvex lens.
